(19) United States
(12) Patent Application Publication
(10) Pub. No.: US 2003/0140950 A1
(43) Pub. Date: Jul. 31, 2003

(54) Cryogenic methods for removing lead based paints from large steel structure

(76) Inventors: Yang Geun Kim, Hayward, CA (US); Eugene Oak, Los Angeles, CA (US); Arnold J. Lee, Castro Valley, CA (US)

Correspondence Address: Eugene OAK, Ph.D., J.D., 610 S. Van Ness Ave., Los Angeles, CA, 90005, US

(21) Appl. No.: 10/057,997

(22) Filed: Jan. 29, 2002

(51) Int. Cl. B08B 7/00

(52) U.S. Cl. 134/38

(57) ABSTRACT

A method is invented to remove lead based paint from a large outdoor steel structure without emission of the lead fragments to the environment. The method of this invention protects the surroundings from contamination by the lead contained in the paint material. The method of this invention utilizes the different thermal expansion coefficients of the paint and the steel structure. Adhesive materials, including but not limited to, epoxy resin monomers, sand particles, grout, are added on the surface of an existing lead based paint layer. A protection layer, including but not limited to a paper and fabrics, is laid on the top of the slurry to soak the monomers in. The epoxy resin is cured firmly by proper activator of, including but not limited to, heat and peroxide. Liquid nitrogen, which is supplied through a rubber hose, is sprayed on the surface of protection layer of, including but not limited to, a “Chang Ho Ji” paper. As the temperature of the composite layer decreases, the volume of the steel layer and the composite paint layer shrink drastically differently to separate the paint layer from the steel surface. The composite paint layer, separated from the steel surface, is ripped off from the steel structure and collected as the temperature reaches back to ambient. Lead, which was contained in the paint, is recovered safely without being blown into the air eventually contaminating the surface water.

This invention relates to a safe method for removing lead based paints from large steel structure without lead contamination to the environment.

### 1. FIELD OF THE INVENTION

A method is invented for removing lead based paints from a large steel structure without lead contamination. Liquid nitrogen is poured through a nozzle at a seasoned stand off distance from the metal surface onto the surface of a composite layer consisting of grout adhesives and protection layer, which is cured on the surface of the paint. Fragments of the paint are collected as adhered to the composite collection layer.

### 2. DESCRIPTION OF THE PRIOR ART

Sand-blasting is the most wide spread technology to take off stains and paints from the surface of an outdoor steel structure such as a chemical vessel, bridge and ship. However, fine particles of size under 30 micrometers raised by the collision of fine sands and the steel surface of the structures causes environmental contamination. In removing lead based paints, the dusts contain fine particles of lead, which are difficult to collect or contain, in the case of a steel bridge, for example, these dusts bring lead into the surface water and cause lead contamination.

U.S. Pat. No. 4,768,535 to Marx, et al. illustrates a device for removing rubber-coated material from large containers by cooling with liquid nitrogen to crack the rubber coatings inside of the container. This method is applicable only to a closed structure for gathering the fragments of broken paints. On the other hands, U.S. Pat. No. 5,938,965 to Madeira and U.S. Pat. No. 4,001,038 to Justice, et al. suggest to remove paint from a work piece by heating and by immersing the object in a molten salt bath, respectively.

U.S. Pat. No. 5,085,999 to Bowers-Irons, et al. discloses a method of removing paint from the surface of metallic aluminum beverage cans by contacting with a mixture of bacteria and nutrient medium.

U.S. Pat. No. 5,130,046 to Boulos, et al. illustrates a paint remover composed of a solvent and an effective thickening agent containing silica micro particles and a co-thickening agent such as a metal salt.

U.S. Pat. No. 5,970,993 to Witherspoon, et al. teaches to use plasma jets at coatings on surfaces to remove paint. U.S. Pat. No. 6,287,389 to McGuire shows a computerized apparatus and method for stripping paint by utilizing ultra-high pressure water jet.

None of the prior art illustrate how to remove lead based paint from large structures without emission of lead to the environment.

### SUMMARY OF THE INVENTION

Therefore, it is the purpose of this invention to provide a method for removing lead based paint from a large outdoor steel structure of bridges, ships and industrial plants without emission of the lead fragments to the environment. The method protects the environment from being contaminated by lead contained in the paint. The method of this invention utilizes a difference in the thermal expansion coefficients of the paint and epoxy grout layer, and that of the steel structure.

Adhesive materials, including but not limited to, epoxy resin grout are applied onto the surface of an existing lead based paint layer. A protection layer, including but not limited to a paper and fabrics, is laid on the top of the slurry to soak the grout materials in. The epoxy resin is cured firmly by use of activators of, including but not limited to, heat and peroxide.

Liquid nitrogen, supplied through a rubber hose, is sprayed on the surface of protection layer of, including but not limited to, the “Chang Ho Ji” paper. As the temperature of the composite layer decreases, the volumes of the steel layer and composite paint layer shrink drastically differently, separating the paint layer from the steel surface. The composite paint layer, separated from the metal surface, is ripped off from the steel structure and collected as the temperature reaches the ambient. Lead, contained in the paint, is recovered safely without being blown into the air and dissolved into surface water.

### BRIEF DESCRIPTION OF THE DRAWINGS

FIG. 1 is a block diagram of the procedure of this invention.

FIG. 2 is a schematic diagram of formation of the monomer on the paint/steel interface.

FIG. 3 is the schematic diagram showing application of the liquid nitrogen Causing thermal shock.

FIG. 4 is a diagram depicting lead based paint removing step.

### DETAILED DESCRIPTION OF THE PREFERRED EMBODIMENTS

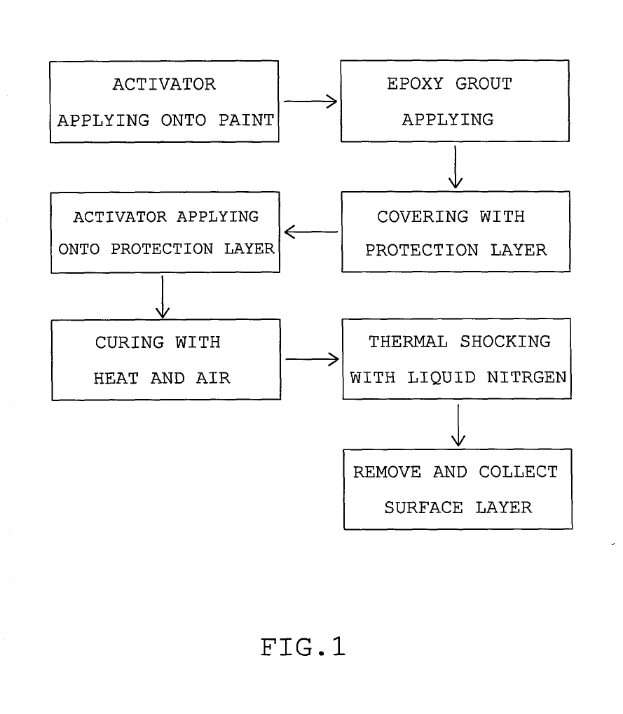

FIG. 1 is the bock diagram of the method of this invention. The method consists of applying activators on the surface, applying epoxy grout on the surface and covering the surface of the monomers with the protection layer, applying the activators, curing the composite layer, thermal shock with liquid nitrogen and removing the composite layer.

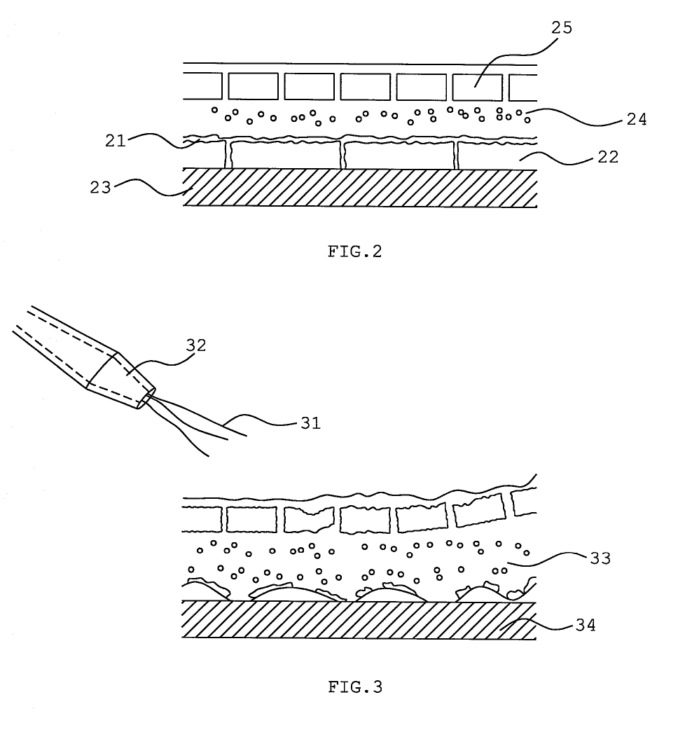

FIG. 2 is a schematic diagram of the constituent structures formed by the method of this invention. Activators for the adhesives (21) are applied on the paint layer (22) of the existing steel structure (23). Monomers (24) of adhesives and grout are, including but not limited to, soaked on the surface of paint layer (22). Surface protector (25), including but not limited, wire mesh, cloths, and paper are patched and scrubbed on the monomer layer (24) to soak-in the monomer. Additional activators (21), which may be the same as the previous one, are sprayed on the surface of the protection layer (25). Heat and air are provided on the surface of the protection layer for at least 24 hrs.

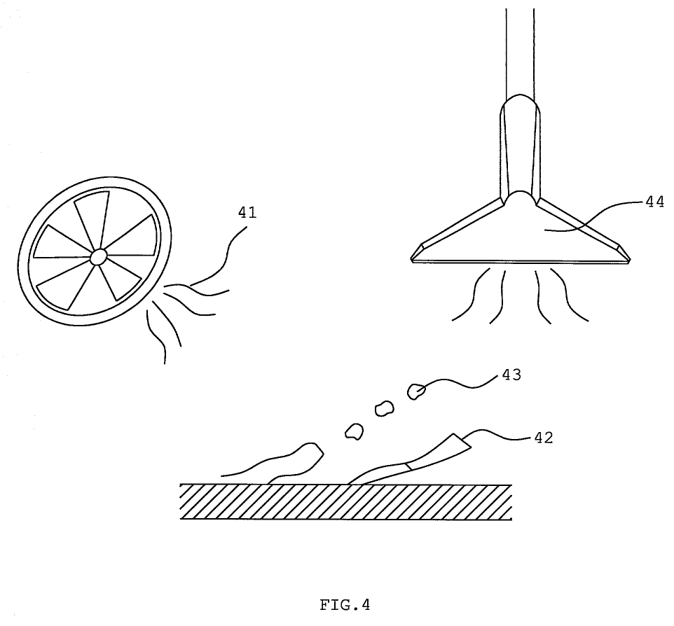

FIG. 3 is the schematic diagram of the structure change by the liquid nitrogen thermal shock. Liquid nitrogen (31), supplied through a rubber hose nozzle (32), is sprayed on the firmly developed composite layer (33) at the previous step. Seasoned distances 1) between the nozzle and the surface, and 2) between sweeping lines for each application are needed to maintain the hardware's surface temperature around −80° C. at least for an hour and for easy peeling off of the protection layer. At this temperature, the steel layer (34) of the structure shrinks 0.36% of that at ambient temperature, meanwhile, the shrinkage of the composite layer (33) is 5% depending on the composition. The two layers are separated for the difference in the shrunken volumes.

FIG. 4 is a diagram depicting lead based paint removing step. After the thermal shock with liquid nitrogen, air (41) is blown to bring the temperature to the ambient state. Paints are recovered by ripping off the protection layer and peeling off by a scrubber (42). Fractures of the paints (43) are collected by a vacuum (44) to leach the lead from the paint.

The best mode of this invention is to use “Chang Ho Ji” for the protection layer and use EPOXY grout for the adhesive layer.

What is claimed is:

1. A lead based paint removing method from large scale outdoor steel structure uses liquid nitrogen for its cryogenic temperature for separating the paint layer from the steel structure and using adhesive protecting layer for collecting the lead based paint fracture without emitting them to the environment.

2. The adhesive protecting layer in claim 1 is composed of epoxy grout layer and “Chang Ho Ji” paper layer.

3. The adhesive protecting layer in claim 1 is cured firmly with the activator and heat before the thermal shock is caused by the liquid nitrogen.

4. The liquid nitrogen in claim 1 is applied on the surface of the protecting layer maintaing seasoned stand-off distances of 0.001 mm to 5 cm from the surface and between sweeping lines in parallel to keep the temperature of the composite surface at −80° C. for one hour and for easy peeling off.

5. The liquid nitrogen in claim 1 is sprayed on the surface of the protecting layer to keep the temperature of the composite surface at −150° C. for 10 hrs.

6. The paint fragments in claim 1 are collected by commercially available vacuum cleaners.
